(19) United States
(12) Patent Application Publication
(10) Pub. No.: US 2025/0015324 A1
(43) Pub. Date: Jan. 9, 2025

(54) FUEL CELL SYSTEM

(71) Applicant: HONDA MOTOR CO., LTD., TOKYO (JP)

(72) Inventors: Kazuhide INOUE, WAKO-SHI, SAITAMA-KEN (JP); Kazusa ISHIKAWA, WAKO-SHI, SAITAMA-KEN (JP)

(21) Appl. No.: 18/760,351

(22) Filed: Jul. 1, 2024

(30) Foreign Application Priority Data
Jul. 7, 2023 (CN) 202310834117.9

(51) Int. Cl. H01M 8/04664; H01M 8/04082; H01M 8/0438; H01M 8/04537; H01M 8/04858

(52) U.S. Cl. CPC H01M 8/04679; H01M 8/04201; H01M 8/04432; H01M 8/04589; H01M 8/0494

(57) ABSTRACT

In a fuel cell system for supplying a fuel gas from a fuel container to a fuel cell through injectors, in a case where a generated current of the fuel cell is equal to or greater than a detection-effective current threshold, failure determination for the injectors is performed based on a fuel gas pressure command value and a gas pressure detection value detected by each of pressure sensors provided downstream of the injectors.

### CROSS-REFERENCE TO RELATED APPLICATIONS

This application is based upon and claims the benefit of priority from Chinese Patent Application No. 202310834117.9 filed on Jul. 7, 2023, the contents of which are incorporated herein by reference.

### BACKGROUND OF THE INVENTION

### Field of the Invention

The present invention relates to a fuel cell system including a fuel cell that generates electric power by an electrochemical reaction between an oxygen-containing gas and a fuel gas.

### Description of the Related Art

In recent years, research and development have been conducted on fuel cells that contribute to energy efficiency, in order to ensure that more people have access to affordable, reliable, sustainable and modern energy.

For example, JP 2018-101572 A discloses a fuel cell system in which hydrogen gas supplied from a hydrogen tank is supplied to a fuel cell stack via a plurality of injectors, wherein a technique for detecting a closing failure of the injectors by disposing a pressure sensor on the downstream side of the plurality of injectors is disclosed.

In this technique, there are provided a normal mode in which one of the plurality of injectors is driven, and a high-load mode in which two or more of the plurality of injectors are driven in a case where the required electric power is equal to or greater than a predetermined value. Under the condition that the normal mode can be performed, a driving command is output to each of all the plurality of injectors, and a closing failure of one injector driven under the driving command is detected in a case where the pressure measured by the pressure sensor after a time point at which the driving command is output is lower than a predetermined threshold.

### SUMMARY OF THE INVENTION

However, in the fuel cell system disclosed in JP 2018-101572 A, there is a problem that, in the normal mode, the driving command is output to each of all the plurality of injectors, and the pressure is measured by the sensor disposed on the downstream side of the injectors, and therefore it takes long time until the detection for the plurality of injectors is completed.

Further, since the detection of the closing failure is performed in the normal mode without performing the detection of the closing failure in the high load mode, there is a problem that a timing of performing the detection of the closing failure is limited and the detection cannot be efficiently performed.

An object of the present invention is to solve the above-described problem.

According to an aspect of the present invention, there is provided a fuel cell system comprising: a fuel cell configured to generate electric power by an electrochemical reaction between an oxygen-containing gas and a fuel gas, and supply the electric power to a load; a fuel container configured to store the fuel gas; a fuel supply flow path configured to guide the fuel gas supplied from the fuel container, to the fuel cell; a plurality of injectors provided in the fuel supply flow path, the injectors being configured to supply the fuel gas to the fuel cell after regulating a pressure of the fuel gas; a pressure sensor configured to detect the pressure of the fuel gas on a downstream side of the plurality of injectors; a control device configured to control power generation of the fuel cell; and a failure determination unit configured to perform failure determination for the injectors, wherein the control device opens and closes the plurality of injectors in accordance with a fuel gas pressure command value that is based on a request from the load, to discharge the fuel gas into the fuel supply flow path, and in a case where a current value output from the fuel cell is equal to or greater than a detection-effective current threshold, the failure determination unit performs the failure determination for the injectors based on the fuel gas pressure command value and a gas pressure detection value detected by the pressure sensor.

According to the present invention, since the failure determination unit performs the failure determination by opening and closing the plurality of injectors, it is possible to shorten the time until the failure determination for the plurality of injectors is confirmed, and it is possible to efficiently perform the failure determination.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a fuel cell system according to an embodiment in which a fuel cell is electrically connected to a load;

FIG. 2 is a flowchart for explaining the operation of the fuel cell system;

FIG. 3 is a timing chart for explaining the operation of the fuel cell system; and

FIG. 4 is a timing chart for explaining the operation of the fuel cell system according to a modification.

### DETAILED DESCRIPTION OF THE INVENTION

### Embodiment

### [Configuration]

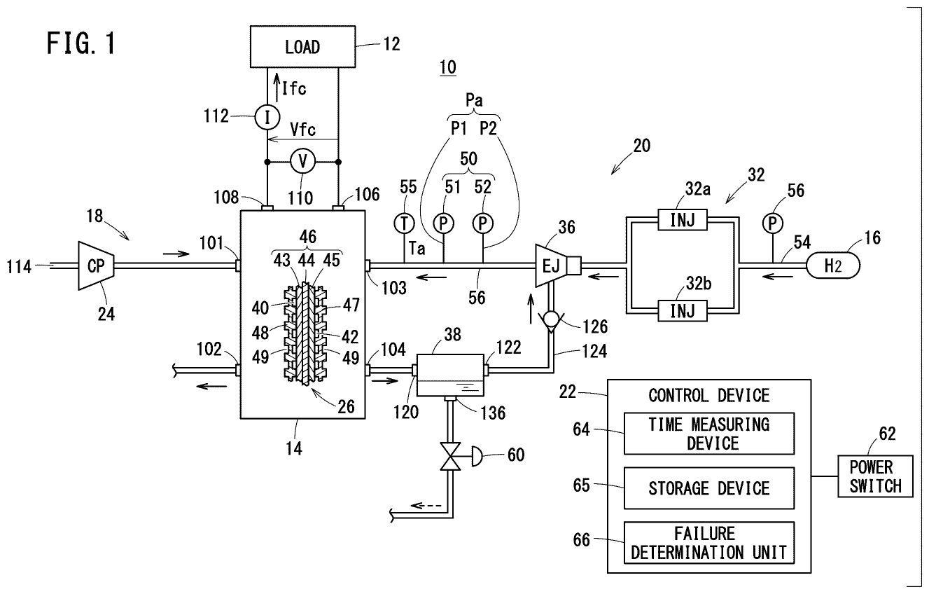

FIG. 1 is a schematic configuration diagram of a fuel cell system 10 according to an embodiment in which a fuel cell is electrically connected to a load. In the fuel cell system 10, a fuel cell stack (also simply referred to as a fuel cell) 14 is electrically connected to a load 12. The fuel cell stack 14 is formed by stacking a plurality of power generation cells 26.

The fuel cell system 10 is used by being incorporated in a moving object such as a fuel cell vehicle, a ship, a submarine, an aircraft, a spacecraft, a robot, an industrial vehicle, or a forklift. The fuel cell stack 14 supplies electric power to a moving object driving electric motor serving as the main load 12, and an auxiliary device serving as an auxiliary load. The fuel cell system 10 is also used to supply electric power to various devices in a stationary plant or the like.

The fuel cell system 10 includes the fuel cell stack 14, a fuel container 16 as a hydrogen tank, an oxygen-containing gas supply device 18, a fuel gas supply device 20, a heat medium supply device (not shown) serving as the auxiliary device and adjusting the temperature of the fuel cell stack 14, and a control device 22 for controlling these devices. The number of the control devices 22 may not be one, and two or more control devices 22 may be provided.

The oxygen-containing gas supply device 18 includes a compressor 24 that is an auxiliary device that compresses the taken-in air and supplies the compressed air to the fuel cell stack 14.

The fuel gas supply device 20 includes: a plurality of injectors (INJ) 32 (a first injector 32a, and a second injector 32b) that regulate the pressure of a fuel gas; an ejector 36; and a gas-liquid separator 38. The first injector 32a and the second injector 32b are connected in parallel.

The fuel gas is supplied from the fuel container 16 to a supply port of each of the injectors 32. The injectors 32 each include therein a piston driven by an electromagnetic coil, and discharge a predetermined amount of the fuel gas by opening and closing a discharge port based on the forward and backward movement of the piston. The number of the injectors 32 may be three or more. The plurality of injectors 32 preferably have the same specifications, but may have different specifications. The injector 32 having optimum specifications is selected according to the required discharge amount of the fuel gas and the operation pattern. The maximum discharge amount that can be discharged by the injector 32 depends on the effective cross-sectional area of the discharge port of the injector 32.

The fuel cell stack 14 includes a stacked body in which the plurality of power generation cells 26 of a solid polymer electrolyte fuel cell (PEFC) are stacked, and is configured by sandwiching the stacked body between a pair of end plates. Each of the power generation cells 26 includes a membrane electrode assembly 46 in which a solid polymer electrolyte membrane (electrolyte membrane) 44 is sandwiched between a cathode 43 and an anode 45, and a pair of separators 47 and 48 that sandwich the membrane electrode assembly 46. The separators 47 and 48 are each formed of a carbon plate or a metal plate. The fuel cell stack 14 is not limited to being constituted by the solid polymer electrolyte fuel cell, and may be constituted by a known fuel cell such as a solid oxide fuel cell (SOFC).

A cathode flow field (oxygen-containing gas flow field) 40 that connects an oxygen-containing gas inlet connection port 101 and an oxygen-containing gas outlet connection port 102 is formed in one surface of the separator 48 that faces the membrane electrode assembly 46. Further, a heat medium flow field 49 is formed in the other surface of the separator 48.

An anode flow field (fuel gas flow field) 42 that connects a fuel gas inlet connection port 103 and a fuel gas outlet connection port 104 is formed in one surface of the separator 47 that faces the membrane electrode assembly 46. Further, the heat medium flow field 49 is also formed in the other surface of the separator 47.

In the anode 45, by the fuel gas (hydrogen gas) being supplied thereto, hydrogen ions (protons) and electrons are generated from hydrogen molecules by an electrode reaction by the catalyst. The hydrogen ions permeate through the solid polymer electrolyte membrane 44 and move to the cathode 43. It should be noted that the fuel gas may be any gas containing hydrogen gas, and may be a hydrogen-containing reformed gas produced by reforming a hydrocarbon fuel.

The electrons generated from the hydrogen molecules move from a negative electrode terminal 106 to the cathode 43 through the load 12 and a positive electrode terminal 108.

In the cathode 43, the hydrogen ions and the electrons react with oxygen contained in an oxygen-containing gas (air) supplied through the compressor 24 by the action of the catalyst, and water is produced. It should be noted that the oxygen-containing gas may be any gas containing oxygen, and may be pure oxygen.

A voltage sensor 110 for detecting a generated voltage Vfc is provided between wiring lines that respectively connect the negative electrode terminal 106 and the positive electrode terminal 108 of the fuel cell stack 14 to the load 12. Further, a current sensor 112 for detecting a generated current Ifc (current value) output from the fuel cell stack 14 is provided on the wiring line that connects the positive electrode terminal 108 to the load 12. The current sensor 112 is directly connected to the positive electrode terminal 108 of the fuel cell stack 14. That is, a voltage converter such as a DC/DC converter is not interposed between the current sensor 112 and the positive electrode terminal 108 of the fuel cell stack 14. As a result, the current sensor 112 can accurately detect the generated current Ifc output from the fuel cell stack 14.

The electric power generated by the fuel cell stack 14 is also used to drive the auxiliary devices such as the compressor 24.

The compressor 24 sucks air from an outside air intake port 114 and pressurizes the air. The pressurized air is supplied as the oxygen-containing gas from the oxygen-containing gas inlet connection port 101 to the cathode flow field 40 in the fuel cell stack 14. The oxygen-containing gas that has flowed through the cathode flow field 40 is supplied to the cathode 43.

The fuel container 16 is a container that stores therein high-purity hydrogen gas (fuel gas) compressed to a high pressure. The fuel container 16 is provided with an electromagnetically operated shutoff valve at the hydrogen supply port thereof.

The fuel gas discharged from the fuel container 16 passes through the injectors 32 (the first injector 32a and the second injector 32b) and the ejector 36 that are provided in a fuel gas discharge pipe 54 (a fuel supply flow path), and is supplied to the anode flow field 42 in the fuel cell stack 14 through a fuel gas supply pipe 56 (the fuel supply flow path) and through the fuel gas inlet connection port 103. The fuel gas that has flowed through the anode flow field 42 is supplied to the anode 45.

The fuel gas supply pipe 56 is provided with a temperature sensor 55 for detecting the temperature of the fuel gas supplied to the fuel cell stack 14, and pressure sensors 50 for detecting the pressure of the fuel gas supplied to the fuel cell stack 14. The pressure sensors 50 include two pressure sensors 51 and 52. The pressure sensors 50 detect the pressure of the fuel gas after the pressure thereof is regulated (reduced) by the injectors 32. In the present embodiment, two pressure sensors 50 are provided in parallel to ensure redundancy. As a result, even when one of the two pressure sensors 51 and 52 fails, the control can be continued by using the remaining one. The specifications of the two pressure sensors 51 and 52 are the same.

The number of the pressure sensors 50 may be one, or three or more. Further, the specifications of the two pressure sensors 50 may be different from each other. In this case, the pressure sensor 51 may be used for detection of a region where the pressure of the fuel gas is relatively low, and the pressure sensor 52 may be used for detection of a region where the pressure of the fuel gas is relatively high.

The pressure value of the fuel gas detected by the pressure sensor 51 is defined as P1, and the pressure value of the fuel gas detected by the pressure sensor 52 is defined as P2. It should be noted that the pressure value of the fuel gas flowing through the fuel gas supply pipe 56 is P1 or P2. The mean value {Pa=(P2+P1)/2} of the gas pressure detection value P1 detected by the pressure sensor 51 and the gas pressure detection value P2 detected by the pressure sensor 52 may be used as the pressure value of the fuel gas. Alternatively, either P1 or P2 may be used as the pressure value of the fuel gas.

Hereinafter, the pressure value detected by each pressure sensor 50 is referred to as a gas pressure detection value Pa.

In the fuel cell stack 14, the oxygen-containing gas and the fuel gas flowing through the cathode 43 and the anode 45, respectively, cause an electrochemical reaction to generate electric power. Then, the generated electric power is supplied to the load 12 through the positive electrode terminal 108 and the negative electrode terminal 106.

The oxygen-containing gas, in which a part of oxygen has been consumed in the fuel cell stack 14, is discharged to the outside (the atmosphere) through the oxygen-containing gas outlet connection port 102 as a nitrogen-rich oxygen-containing off-gas.

The fuel gas, in which a part of hydrogen gas has been consumed in the fuel cell stack 14, flows into an inlet 120 of the gas-liquid separator 38 through the fuel gas outlet connection port 104 as a fuel off-gas which is a hydrogen-containing gas. The fuel off-gas discharged from the anode flow field 42 is supplied to the gas-liquid separator 38.

The gas-liquid separator 38 separates the fuel off-gas into a gas component and a liquid component (liquid water) containing reaction product water. The gas component of the fuel off-gas includes hydrogen gas discharged without being used for the electrochemical reaction in the fuel cell stack 14, nitrogen that has permeated from the cathode flow field 40 to the anode flow field 42 through the electrolyte membrane 44, and a gas component of the reaction product water. The gas component is discharged from a gas discharge port 122 of the gas-liquid separator 38 and is supplied to the suction port of the ejector 36 through a reed valve 126 in a circulation pipe 124. The reed valve 126 is a check valve and prevents the gas component from flowing back from the ejector 36 to the gas-liquid separator 38.

The liquid component of the fuel off-gas flowing from a liquid discharge port 136 of the gas-liquid separator 38 through a drain valve 60 may be mixed with the oxygen-containing off-gas, and discharged to the outside (the atmosphere) via a diluter (not shown).

The above-described components of the fuel cell system 10 are controlled in an integrated manner by the control device 22.

The control device 22 is constituted by an electronic control unit (ECU). The ECU is constituted by a computer including one or more processors (CPUs), a memory, an input/output interface, and an electronic circuit. The one or more processors (CPUs) execute non-illustrated programs (computer-executable instructions) stored in the memory.

The control device 22 performs all controls related to power generation of the fuel cell system 10.

The control device 22 includes a time measuring device 64 which is a timer, and a storage device 65 which stores various kinds of information in the memory.

The control device 22 includes a failure determination unit 66 that performs failure determination for the injectors 32.

The processors (CPUs) of the control device 22 execute the programs to control the operation of the fuel cell system 10.

A power switch 62 for turning on and off the fuel cell system 10 is connected to the control device 22. The power switch 62 starts or continues (ON) or terminates (OFF) the power generation operation of the fuel cell stack 14 of the fuel cell system 10.

### [Operation]

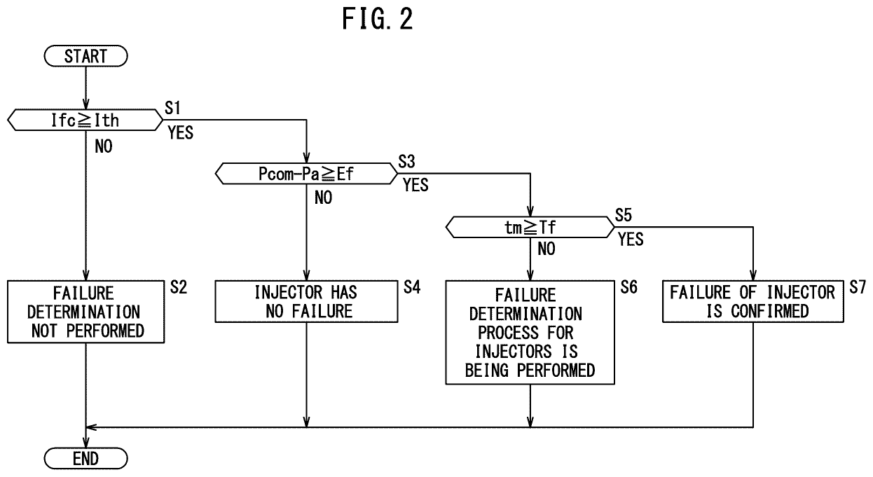

The fuel cell system 10 according to the present embodiment is basically configured as described above. The operation will be described below with reference to the flowchart shown in FIG. 2. The process according to the flowchart of FIG. 2 is repeatedly executed by the control device 22 at a predetermined cycle.

The control device 22 performs failure determination control of the fuel cell system 10 when the power switch 62 is in the ON state. Specifically, the failure determination unit 66 of the control device 22 performs failure determination control for a closing failure of the injector 32 that discharges hydrogen gas that is the fuel gas supplied to the fuel cell stack 14.

During normal power generation operation, the control device 22 causes the fuel cell stack 14 to output electric power based on a request from the load 12. Specifically, the control device 22 refers to the map stored in the storage device 65, causes the injector 32 to discharge the fuel gas in an amount equal to or greater than a fuel gas pressure command value Pcom corresponding to a required current from the load 12, and causes the fuel cell stack 14 to output the generated current Ifc corresponding to the required current.

In step S1, the failure determination unit 66 determines whether or not the generated current Ifc is equal to or greater than a detection-effective current threshold Ith.

Here, the detection-effective current threshold Ith will be described.

The control device 22 can cause the fuel cell stack 14 to output the generated current Ifc of a predetermined value or more. The generated current Ifc (current value) of the predetermined value is referred to as the detection-effective current threshold Ith. The control device 22 preferably maintains the detection-effective current threshold Ith at a constant value while the failure determination unit 66 performs the failure determination.

The detection-effective current threshold Ith is a maximum current value that can be output by the fuel cell stack 14 generating electric power using a maximum amount of hydrogen gas (maximum amount of the fuel gas) that can be discharged by only one of the plurality of injectors 32. Alternatively, the detection-effective current threshold Ith is a specific current value set based on the maximum current value.

As another embodiment, the detection-effective current threshold Ith is a constant current value output from the fuel cell stack 14 using a constant amount of the fuel gas discharged from only one of the two injectors 32 (the first injector 32a and the second injector 32b) when the two injectors 32 are driven simultaneously. The constant amount of the fuel gas means that the amount of the fuel gas discharged from the injector 32 per unit time is constant. Since one of the injectors 32 discharges the constant amount of the fuel gas, the pressure change of the fuel gas discharged by the other injector 32 can be accurately detected. If the discharge amount of the fuel gas discharged by one of the injectors 32 changes, the discharge amount of the fuel gas interferes with the discharge amount of the fuel gas discharged by the other injector 32, and it is difficult to accurately detect the pressure change of the fuel gas using the pressure sensors 50 provided downstream of the two injectors 32.

There is a case where the control device 22 causes the fuel cell stack 14 to output the generated current Ifc equal to or greater than the detection-effective current threshold Ith based on the required current from the load 12. In this case, since the amount of the fuel gas discharged from one injector 32 is insufficient for the required current, it is necessary to drive two injectors 32 simultaneously. One of the two injectors 32 discharges the maximum amount of the fuel gas, and the other injector 32 discharges the fuel gas in an amount corresponding to the insufficiency that cannot be compensated by the maximum amount of the fuel gas discharged by the one injector 32.

The generated current Ifc (current value) is not limited to being a constant value and may vary with time as long as the generated current Ifc is equal to or greater than the detection-effective current threshold Ith. In this case, in the present embodiment, one of the injectors 32 discharges a fixed constant maximum amount of the fuel gas, and the other injector 32 changes the discharge amount of the fuel gas in accordance with the required current from the load 12.

In a case where it is determined in step S1 that the generated current Ifc is less than the detection-effective current threshold Ith (step S1: NO), the failure determination unit 66 advances the process to step S2. In step S2, the failure determination unit 66 does not perform the failure determination (failure determination not performed).

In a case where it is determined in step S1 that the generated current Ifc is equal to or greater than the detection-effective current threshold Ith (step S1: YES), the failure determination unit 66 advances the process to step S3.

In step S3, the failure determination unit 66 determines whether or not the difference obtained by subtracting the gas pressure detection value Pa detected by the pressure sensor 50 from the fuel gas pressure command value Pcom is equal to or greater than a first detection difference Ef.

The first detection difference Ef includes a control error related to the control, and a detection error of each pressure sensor 50.

In a case where the difference between the fuel gas pressure command value Pcom and the gas pressure detection value Pa is less than the first detection difference Ef (step S3: NO), the failure determination unit 66 advances the process to step S4.

In step S4, the failure determination unit 66 determines that the injector 32 has no failure.

On the other hand, in a case where the difference between the fuel gas pressure command value Pcom and the gas pressure detection value Pa is equal to or greater than the first detection difference Ef (step S3: YES), the failure determination unit 66 advances the process to step S5. At the same time as the process proceeds to step S5, the time measuring device 64 is operated to start measuring an elapsed time tm, and a flag indicating that the failure detection is being performed is set.

In step S5, the failure determination unit 66 determines whether or not the elapsed time tm in the state where the process has proceeded to step S5 has passed a first failure confirmation time Tf, which is a predetermined time from the setting of the flag indicating that the failure detection is being performed (tm Tf).

In a case where the first failure confirmation time Tf has not elapsed (step S5: NO), the failure determination unit 66 advances the process to step S6.

In step S6, the failure determination unit 66 determines that the failure determination process for the injectors 32 is being performed, and the process returns to step S1.

In a case where the first failure confirmation time Tf has elapsed from the setting of the flag indicating that failure detection is being performed (step S5: YES), the failure determination unit 66 advances the process to step S7.

In step S7, the failure determination unit 66 confirms a failure of the injector 32.

If the failure of the injector 32 is confirmed, the control device 22 may activate a warning device, such as a lamp or buzzer, to indicate the failure.

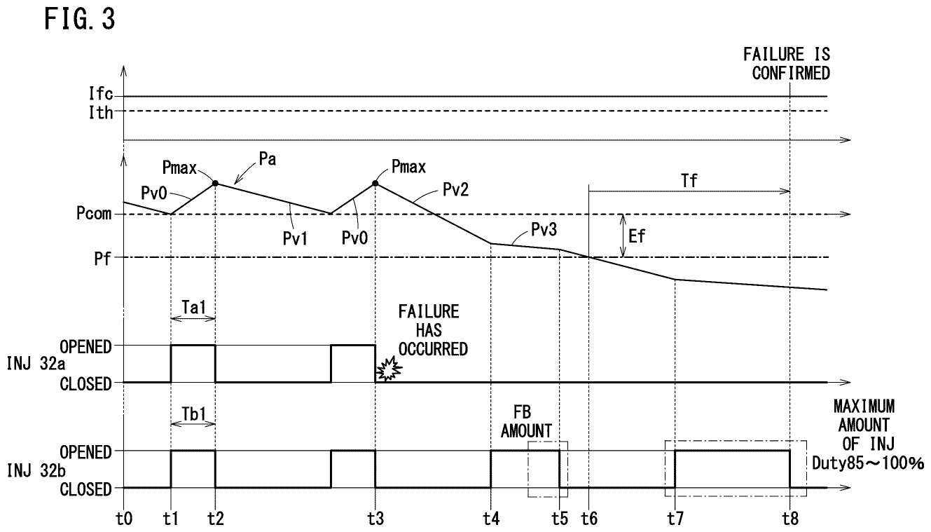

Next, an example of the process according to the flowchart of FIG. 2 will be described with reference to the timing chart of FIG. 3.

At a time point t0, based on the required current from the load 12, the control device 22 refers to the map of the storage device 65 in which the relationship between the generated current Ifc and the fuel gas pressure command value Pcom is stored. In this case, the control device 22 drives the injectors 32 based on the fuel gas pressure command value Pcom corresponding to the generated current Ifc. The map may be switched based on a temperature Ta of the hydrogen gas flowing through the fuel gas supply pipe 56, as detected by the temperature sensor 55.

In this case, in the present embodiment, as shown in FIG. 3, the first injector 32a and the second injector 32b repeat valve opening and valve closing at the same time to discharge a predetermined amount of the fuel gas after the time point t0.

The relationship between the fuel gas pressure command value Pcom and the amount of the fuel gas discharged from each of the first injector 32a and the second injector 32b is stored in the storage device 65 in advance as a map.

In this example, when the fuel gas pressure command value Pcom is small, one injector 32 discharges the fuel gas, and when the fuel gas pressure command value Pcom becomes large, two injectors 32 discharge the fuel gas. In consideration of the durable life of the plurality of injectors 32, the first injector 32a and the second injector 32b may be used while being switched from one to another so that the times during which the injectors 32 are driven according to the fuel gas pressure command value Pcom are equal to each other.

The fuel gas discharged from the injectors 32 is consumed by (A) power generation by the electrochemical reaction in the fuel cell stack 14, (B) movement of the fuel gas from the anode 45 to the cathode 43 through the electrolyte membrane 44, and (C) discharge of the fuel gas from the gas-liquid separator 38 to the outside via the liquid discharge port 136. The gas pressure detection value Pa detected by the pressure sensors 50 is determined based on the amount of the fuel gas discharged from the injectors 32 and supplied to the fuel cell stack 14, and the amount of the fuel gas consumed by the above (A), (B), and (C).

In the present embodiment, the first injector 32a and the second injector 32b are simultaneously opened for predetermined times Ta1 and Tb1, respectively, to discharge a predetermined amount of the hydrogen gas into the fuel gas supply pipe 56. The time Ta1 and the time Tb1 may be the same or different. Further, the valve opening timing of the first injector 32a and the valve opening timing of the second injector 32b may be different from each other.

The flow rate of the fuel gas discharged by the injectors 32 within a predetermined time can be adjusted by changing the duty ratio of the valve opening and the valve closing. The duty ratio of the first injector 32a and the duty ratio of the second injector 32b may be the same or different.

When the injectors 32 are opened, the fuel gas is discharged into the fuel gas supply pipe 56, and the gas pressure detection value Pa detected by the pressure sensors 50 increases at an increasing speed Pv0 after a time point t1. Then, at a time point t2, the gas pressure detection value Pa reaches a maximum value Pmax.

The failure determination unit 66 starts the failure determination in a case where the gas pressure detection value Pa is greater than the fuel gas pressure command value Pcom. It should be noted that the failure determination may be started at the time point when the gas pressure detection value Pa reaches the maximum value Pmax.

The failure determination unit 66 may start the failure determination in a case where the fuel gas pressure command value Pcom corresponding to the generated current Ifc is within a predetermined range. The predetermined range is determined based on a control error which is an error in pressure control. The failure determination may be started within a predetermined range of the fuel gas pressure command value Pcom in which the control error is reduced.

After the time point t2, the gas pressure detection value Pa gradually decreases at a decreasing speed Pv1 as the fuel gas is consumed mainly by the electrochemical reaction in the fuel cell stack 14 on the downstream side of the injectors 32.

In this case, the control device 22 drives the injectors 32 based on the map stored in advance in the storage device 65 to discharge the fuel gas so that the gas pressure detection value Pa is equal to or greater than the fuel gas pressure command value Pcom even when the gas pressure detection value Pa is most decreased.

In the present embodiment, a case will be described where a closing failure occurs in the first injector 32a among the first injector 32a and the second injector 32b when the gas pressure detection value Pa reaches the maximum value Pmax (at a time point t3). The closing failure refers to a state in which the discharge port of the injector 32 is closed and the fuel gas cannot be discharged.

When the closing failure occurs in the first injector 32a at the time point t3 in FIG. 3, the gas pressure detection value Pa detected by the pressure sensors 50 decreases from the maximum value Pmax at a decreasing speed Pv2 higher than the decreasing speed in the case where the closing failure has not occurred. Then, when the gas pressure detection value Pa falls below the fuel gas pressure command value Pcom, the control device 22 issues a command to the second injector 32b based on feedback control so as to increase the discharge amount and increase the gas pressure detection value Pa.

In this case, the closing failure has already occurred in the first injector 32a, and the first injector 32a does not discharge the fuel gas. The remaining normal second injector 32b increases the discharge amount of the fuel gas corresponding to the feedback (FB) amount, and therefore, a decreasing speed Pv3 (|Pv2|>|Pv3|) of the gas pressure detection value Pa temporarily decreases (from a time point t4 to a time point t5).

In a case where, even if the discharge amount of the fuel gas corresponding to the feedback amount is increased, the gas pressure detection value Pa further decreases and becomes lower than a first detection threshold Pf, the failure determination unit 66 detects the failure of the first injector 32a (see a time point t6, step S3: YES).

At this time point t6, the failure of the first injector 32a has not been confirmed yet. The first detection threshold Pf is a pressure value lower than the fuel gas pressure command value Pcom by the first detection difference Ef. As described above, the first detection difference Ef is set in consideration of the control error related to the control and the detection error of each pressure sensor 50.

The control error is generated when, due to the power generation state of the fuel cell stack 14, the actual consumption amount of the fuel gas deviates from the amount of the fuel gas discharged from the injectors 32 based on the fuel gas pressure command value Pcom.

The error of each pressure sensor 50 is caused by a detection error of the pressure sensor 50 itself, and the state (the pressure distribution, the flow velocity, the temperature, or the like) of the fuel gas flowing through the inside of the fuel gas supply pipe 56. The detection error of the pressure sensor 50 itself may be more accurately grasped by reflecting the influence of the pressure distribution, the flow velocity, and the temperature in the gas pressure detection value Pa.

After detecting the failure at the time point t6, the failure determination unit 66 monitors whether or not a state in which the gas pressure detection value Pa is lower than the first detection threshold Pf continues. Then, if this state continues even after the first failure confirmation time Tf has elapsed (see step S5: YES), it is determined that the failure has been confirmed (see a time point t8 and step S7).

When the failure of the first injector 32a is confirmed by the failure determination unit 66, the control device 22 sets, as an upper limit value, the maximum amount of the fuel gas that can be discharged from the normal second injector 32b, and causes the fuel cell stack 14 to continue the power generation using the fuel gas in an amount not exceeding the upper limit value. The maximum amount of the fuel gas that can be discharged depends on the effective cross-sectional area of the second injector 32b, and the duty ratio of the second injector 32b is normally about 85% to 100%.

In this case, the amount of the fuel gas discharged from the injectors 32 may be insufficient for the required current from the load 12, and therefore, the generated current Ifc output from the fuel cell stack 14 needs to be limited quickly. This is because, if the amount of the fuel gas supplied from the injectors 32 is insufficient for the required current from the load 12, the supply of the fuel gas to the anode 45 becomes insufficient, and the membrane electrode assembly 46 is damaged, which affects the durability.

Thus, the generated current Ifc corresponding to the maximum amount of the fuel gas that can be discharged from the second injector 32b that is driven normally is set as a limited current value. The limited current value in the present embodiment is the same as the detection-effective current threshold Ith. It should be noted that in a case where the required current from the load 12 exceeds the limited current value, a current is supplied to the load 12 from a battery (not shown) or the like.

### [Modification]

The above embodiment can also be modified as follows.

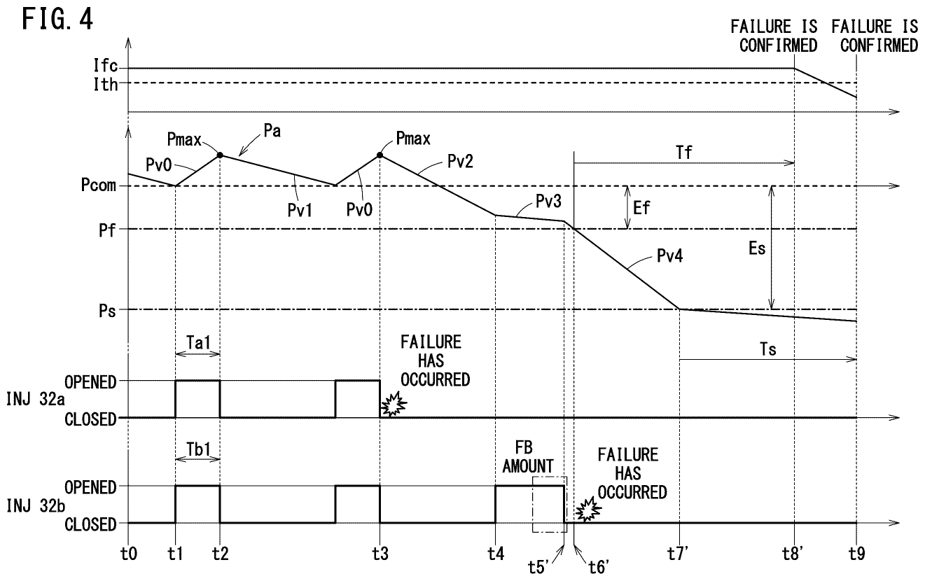

FIG. 4 is a timing chart for explaining the operation in the modification. In FIG. 4, the same events as those in FIG. 3 are denoted by the same reference numerals, and the detailed description thereof will be omitted.

In the timing chart of FIG. 4, the behavior from the time point t1 to the time point t4 is identical to that in the timing chart of FIG. 3. The difference is that a failure has also occurred in the second injector 32b at a time point t5′.

In the timing chart of FIG. 4, a second detection difference Es, which is larger than the first detection difference Ef in the timing chart of FIG. 3, is set as the difference between the fuel gas pressure command value Pcom and the gas pressure detection value Pa. In other words, two detection differences, that is, the first detection difference Ef and the second detection difference Es are set. The second detection difference Es is larger than the first detection difference Ef (Es>Ef). In this case, the first injector 32a has already failed at the time point t3, and the second injector 32b has failed at the time point t5′. Therefore, after the time point t5′, a decreasing speed Pv4 of the gas pressure detection value Pa is higher than the decreasing speed Pv3 before that time point.

After the difference obtained by subtracting the gas pressure detection value Pa from the fuel gas pressure command value Pcom exceeds the first detection difference Ef at a time point t6′, the failure of the first injector 32a is confirmed at a time point t8′ when the first failure confirmation time Tf has elapsed.

On the other hand, at a time point t7′, the gas pressure detection value Pa becomes lower than a detection threshold Ps. That is, after the difference obtained by subtracting the gas pressure detection value Pa from the fuel gas pressure command value Pcom exceeds the second detection difference Es, the failure of the second injector 32b is also confirmed at a time point t9 when a second failure confirmation time Ts has elapsed.

When the failure of the two injectors 32 is confirmed, the control device 22 stops the power generation of the fuel cell stack 14. In this case, a warning device such as a lamp or buzzer may be activated to indicate the failure.

According to this modification, even when the two injectors 32 for supplying the fuel gas fail one after another, the failure can be detected quickly, and the power generation of the fuel cell stack 14 can be stopped, whereby damage to the fuel cell stack 14 due to insufficient supply of the fuel gas can be suppressed.

The present invention is not limited to the above disclosure, and various modifications are possible without departing from the essence and gist of the present invention. For example, the number of the injectors 32 is not limited to two, and may be three or more. In this case, it is preferable to perform the failure determination in a state where all of the three or more injectors 32 are driven. The detection-effective current threshold Ith of the generated current Ifc may be a constant current value output by the fuel cell using mutually different constant amounts of the fuel gas discharged when all of the plurality of injectors 32 except one of the injectors 32 are simultaneously driven. More preferably, the detection-effective current threshold Ith is a current value in a state where the fuel cell stack 14 generates electric power using the maximum amount of the fuel gas that can be discharged from at least one of the plurality of injectors 32.

### Supplementary Note

The following supplementary notes are further disclosed in relation to the above-described disclosure.

### Supplementary Note 1

The fuel cell system (10) is a fuel cell system including: the fuel cell (14) configured to generate electric power by an electrochemical reaction between the oxygen-containing gas and the fuel gas, and supply the electric power to the load (12); the fuel container (16) configured to store the fuel gas; the fuel supply flow path (54, 56) configured to guide the fuel gas supplied from the fuel container (16), to the fuel cell (14); the plurality of injectors (32) provided in the fuel supply flow path, the injectors being configured to supply the fuel gas to the fuel cell after regulating the pressure of the fuel gas; the pressure sensor (50) configured to detect the pressure of the fuel gas on the downstream side of the plurality of injectors (32); the control device (22) configured to control power generation of the fuel cell; and the failure determination unit (66) configured to perform failure determination for the injectors (32), wherein the control device (22) opens and closes the plurality of injectors (32) in accordance with the fuel gas pressure command value Pcom that is based on a request from the load, to discharge the fuel gas into the fuel supply flow path, and in a case where the current value output from the fuel cell (14) is equal to or greater than the detection-effective current threshold Ith, the failure determination unit (66) performs the failure determination for the injectors (32) based on the fuel gas pressure command value and the gas pressure detection value Pa detected by the pressure sensor (50).

According to this configuration, in a case where the current value output from the fuel cell is equal to or greater than the detection-effective current threshold, the failure determination for the injectors is performed based on the fuel gas pressure command value and the gas pressure detection value detected by the pressure sensor, and therefore, the pressure change of the fuel gas can be detected in a state where a stable amount of the fuel gas flows through the fuel supply flow path, and the failure determination for the injectors can be reliably performed.

Further, since the pressure of the fuel gas is detected on the downstream side of the plurality of injectors, it is possible to quickly detect a failure of the injector without performing the failure determination for each individual injector. According to this feature, insufficient supply of the fuel gas due to the failure of the injector can be detected at an early stage and can be dealt with, and the deterioration of the fuel cell can be effectively suppressed.

### Supplementary Note 2

In the fuel cell system according to Supplementary Note 1, in the failure determination for the injectors, the failure determination unit may determine that the injector has failed in a case where a difference obtained by subtracting the gas pressure detection value from the fuel gas pressure command value exceeds the first detection difference Ef.

According to this feature, the influence of the control error related to the control of the fuel cell and the detection error of the pressure sensor is reduced, and thus the failure of the injector can be reliably detected.

### Supplementary Note 3

In the fuel cell system according to Supplementary Note 1, the failure determination unit may start the failure determination in a case where the gas pressure detection value is greater than the fuel gas pressure command value.

According to this feature, the temporal change in the gas pressure detection value can be accurately detected in the process of the gas pressure detection value decreasing.

### Supplementary Note 4

In the fuel cell system according to Supplementary Note 1, the failure determination may be started in a case where the fuel gas pressure command value corresponding to the current value is within a predetermined range.

According to this feature, the detection can be performed in a state where the fuel gas pressure command value is stable with respect to the current value and the control error is small, and the failure of the injector can be reliably detected.

### Supplementary Note 5

In the fuel cell system according to Supplementary Note 1, the plurality of injectors may be two injectors, and the detection-effective current threshold may be a maximum current value that that can be output by the fuel cell with only one of the injectors, or may be a current value based on the maximum current value.

According to this feature, a sufficient decrease in the gas pressure detection value with respect to the fuel gas pressure command value can be detected, and the failure determination can be performed reliably and quickly. Further, at the maximum current value that can be output by the fuel cell with only one of the injectors, the other injector is also driven simultaneously, and therefore, even if a failure occurs in either of the two injectors, it is possible to perform the failure determination.

### Supplementary Note 6

In the fuel cell system according to Supplementary Note 1, the failure determination unit may perform the failure determination in a state where all of the plurality of injectors are driven.

According to this feature, the gas pressure detection value decreases with respect to the fuel gas pressure command value regardless of whichever of the plurality of injectors fails, and therefore, the failure of the injector can be quickly detected.

### Supplementary Note 7

In the fuel cell system according to Supplementary Note 6, the detection-effective current threshold may be a constant current value output by the fuel cell using mutually different constant amounts of the fuel gas discharged by all of the plurality of injectors except one of the injectors.

According to this feature, all of the injectors except one injector discharge the mutually different constant amounts of the fuel gas. Therefore, in a case where the closing failure occurs in any of these injectors, the decreasing speed of the gas pressure detection value becomes different, and the failed injector can be specified. Further, the one injector can vary the discharge amount of the fuel gas in accordance with the varying required current that is required for the fuel cell.

### Supplementary Note 8

In the fuel cell system according to Supplementary Note 7, the failure determination unit may perform the failure determination for the injectors when at least one of the plurality of injectors discharges a maximum dischargeable fuel gas amount.

According to this feature, a sufficient decrease in the gas pressure detection value can be detected, and the failure determination can be performed reliably and quickly.

### Supplementary Note 9

In the fuel cell system according to Supplementary Note 2, the control device may cause the plurality of injectors to increase the amount of the fuel gas to be discharged, in a case where the gas pressure detection value falls below the fuel gas pressure command value.

According to this feature, insufficient supply of the fuel gas caused by the injector in which the failure has occurred is compensated by supplying an increased amount of the fuel gas from the injectors in which the failure does not occur, and the insufficient supply of the fuel gas to the anode can be suppressed.

### Supplementary Note 10

In the fuel cell system according to Supplementary Note 2, in a case where it is determined that at least one of the plurality of injectors has failed, the control device may limit the current output from the fuel cell to a current value or less that can be output by the fuel cell using a maximum fuel gas amount that is dischargeable by the injector that has not failed.

According to this feature, the insufficient supply of the fuel gas to the anode can be suppressed, and the deterioration of the fuel cell stack can be suppressed.

### Supplementary Note 11

In the fuel cell system according to Supplementary Note 2, the failure determination unit may determine that the plurality of injectors have failed in a case where the difference obtained by subtracting the gas pressure detection value from the fuel gas pressure command value exceeds the second detection difference Es larger than the first detection difference.

According to this feature, it is possible to quickly detect that a failure has occurred in two or more injectors.

1. A fuel cell system comprising:
a fuel cell configured to generate electric power by an electrochemical reaction between an oxygen-containing gas and a fuel gas, and supply the electric power to a load;
a fuel container configured to store the fuel gas;
a fuel supply flow path configured to guide the fuel gas supplied from the fuel container, to the fuel cell;
a plurality of injectors provided in the fuel supply flow path, the injectors being configured to supply the fuel gas to the fuel cell after regulating a pressure of the fuel gas;
a pressure sensor configured to detect the pressure of the fuel gas on a downstream side of the plurality of injectors; and
one or more processors that execute computer-executable instructions stored in a memory,
wherein the one or more processors execute the computer-executable instructions to cause the fuel cell system to:
control power generation of the fuel cell;
open and close the plurality of injectors in accordance with a fuel gas pressure command value that is based on a request from the load, to discharge the fuel gas into the fuel supply flow path; and
in a case where a current value output from the fuel cell is equal to or greater than a detection-effective current threshold, perform failure determination for the injectors based on the fuel gas pressure command value and a gas pressure detection value detected by the pressure sensor.

2. The fuel cell system according to claim 1, wherein
the one or more processors cause the fuel cell system to, in the failure determination for the injectors, determine that at least one of the injectors has failed in a case where a difference obtained by subtracting the gas pressure detection value from the fuel gas pressure command value exceeds a first detection difference.

3. The fuel cell system according to claim 1, wherein
the one or more processors cause the fuel cell system to start the failure determination in a case where the gas pressure detection value is greater than the fuel gas pressure command value.

4. The fuel cell system according to claim 1, wherein
the one or more processors cause the fuel cell system to start the failure determination in a case where the fuel gas pressure command value corresponding to the current value is within a predetermined range.

5. The fuel cell system according to claim 1, wherein
the plurality of injectors are two injectors, and
the detection-effective current threshold is a maximum current value outputtable by the fuel cell with only one of the injectors, or is a current value based on the maximum current value.

6. The fuel cell system according to claim 1, wherein
the one or more processors cause the fuel cell system to perform the failure determination in a state where all of the plurality of injectors are driven.

7. The fuel cell system according to claim 6, wherein
the detection-effective current threshold is a constant current value output by the fuel cell using mutually different constant amounts of the fuel gas discharged by all of the plurality of injectors except one of the injectors.

8. The fuel cell system according to claim 7, wherein
the one or more processors cause the fuel cell system to perform the failure determination for the injectors when at least one of the plurality of injectors discharges a maximum dischargeable fuel gas amount.

9. The fuel cell system according to claim 2, wherein
the one or more processors cause the fuel cell system to cause the plurality of injectors to increase an amount of the fuel gas to be discharged, in a case where the gas pressure detection value falls below the fuel gas pressure command value.

10. The fuel cell system according to claim 2, wherein
the one or more processors cause the fuel cell system to, in a case where it is determined that at least one of the plurality of injectors has failed, limit a current output from the fuel cell to a current value or less that is outputtable by the fuel cell using a maximum fuel gas amount that is dischargeable by at least one of the injectors that has not failed.

11. The fuel cell system according to claim 2, wherein
the one or more processors cause the fuel cell system to determine that the plurality of injectors have failed in a case where the difference obtained by subtracting the gas pressure detection value from the fuel gas pressure command value exceeds a second detection difference larger than the first detection difference.
